(19) United States
(12) Patent Application Publication
(10) Pub. No.: US 2026/0046831 A1
(43) Pub. Date: Feb. 12, 2026

(54) METHOD FOR COMMUNICATING SIDELINK POSITIONING REFERENCE SIGNAL, AND DEVICE

(71) Applicant: GUANGDONG OPPO MOBILE TELECOMMUNICATIONS CORP., LTD., Dongguan (CN)

(72) Inventors: Yang LIU, Dongguan (CN); Bingxue LENG, Dongguan (CN)

(21) Appl. No.: 19/366,322

(22) Filed: Oct. 22, 2025

Related U.S. Application Data
(63) Continuation of application No. PCT/CN2023/102487, filed on Jun. 26, 2023.

(51) Int. Cl. H04W 64/00; H04W 72/25; H04W 76/28

(52) U.S. Cl. CPC H04W 64/00; H04W 72/25; H04W 76/28

(57) ABSTRACT

The present disclosure relates to the technical field of mobile communications. Disclosed are a method for communicating a sidelink positioning reference signal (SL-PRS), and a device. The method applicable to a sidelink (SL) communication receiver terminal. The method includes: transmitting or receiving the SL-PRS based on an SL-PRS configuration matching a sidelink discontinuous reception (SL-DRX) configuration.

### CROSS-REFERENCE TO RELATED APPLICATION

This application is a continuation application of international application No. PCT/CN2023/102487, filed on Jun. 26, 2023, the entire disclosure of which is hereby incorporated herein by reference.

### TECHNICAL FIELD

The present disclosure relates to the field of mobile communication, and in particular, relates to a method for communicating a sidelink positioning reference signal (SL-PRS), and a device thereof.

### RELATED ART

The radio electromagnetic waves used in cellular networks are used for wireless data transmission and wireless communication, while also being applicable for positioning.

For sidelink (SL) positioning, a user equipment (UE) acts as an SL-PRS transmitter device to transmit an SL-PRS, while another UE acts as an SL-PRS receiver device to receive and measure the SL-PRS.

In a case where the SL-PRS receiver device is in the sleep time of sidelink discontinuous reception (SL-DRX), two possible outcomes occur. One is that the SL-PRS receiver device does not perform the reception and measurement of the SL-PRS, and the other is that the SL-PRS receiver device forcibly wakes up during the sleep time of SL-DRX to perform the reception and measurement of the SL-PRS.

### SUMMARY

Embodiments of the present disclosure provide a method for communicating an SL-PRS, and a device thereof. The technical solutions are as follows:

According to some embodiments of the present disclosure, a method for communicating an SL-PRS is provided. The method is performed by an SL communication receiver terminal, and includes:
transmitting or receiving the SL-PRS based on an SL-PRS configuration matching an SL-DRX configuration.

According to some embodiments of the present disclosure, a communication device is provided. The communication device includes: a processor, a transceiver connected to the processor, and a memory storing one or more executable instructions; wherein the one or more executable instructions, when loaded and executed by the processor, cause the processor to:
receive a first sidelink discontinuous reception (SL-DRX) configuration, wherein the first SL-DRX configuration is an SL-DRX configuration for a sidelink (SL) communication receiver terminal; and
configure a first SL-PRS configuration matching the first SL-DRX configuration for the SL communication receiver terminal.

According to some embodiments of the present disclosure, a communication device is provided. The communication device includes: a processor, a transceiver connected to the processor, and a memory storing one or more executable instructions; wherein the one or more executable instructions, when loaded and executed by the processor, cause the processor to: receive an expected SL-DRX configuration from a sidelink (SL) communication
receiver terminal, wherein the expected SL-DRX configuration is determined based on a second SL-PRS configuration; and
transmit a second SL-DRX configuration matching the second SL-PRS configuration to the SL communication receiver terminal.

### BRIEF DESCRIPTION OF THE DRAWINGS

For clearer descriptions of the technical solutions according to the embodiments of the present disclosure, the following briefly introduces the accompanying drawings required for describing the embodiments. Apparently, the accompanying drawings in the following description show merely some embodiments of the present disclosure, and persons of ordinary skill in the art still derive order drawings from these accompanying drawings without creative efforts.

FIG. 1 is an architecture diagram of a communication network according to some embodiments of the present disclosure;

FIG. 2 is a flowchart of a method for communicating an SL-PRS according to some embodiments of the present disclosure;

FIG. 3 is a flowchart of a method for configuring an SL-PRS according to some embodiments of the present disclosure;

FIG. 4 is a flowchart of a method for communicating an SL-PRS according to some embodiments of the present disclosure;

FIG. 5 is a flowchart of a method for communicating an SL-PRS according to some embodiments of the present disclosure;

FIG. 6 is a flowchart of a method for communicating an SL-PRS according to some embodiments of the present disclosure;

FIG. 7 is a flowchart of a method for communicating an SL-PRS according to some embodiments of the present disclosure;

FIG. 8 is a flowchart of a method for communicating an SL-PRS according to some embodiments of the present disclosure;

FIG. 9 is a flowchart of a method for communicating an SL-PRS according to some embodiments of the present disclosure;

FIG. 10 is a flowchart of a method for configuring an SL-PRS according to some embodiments of the present disclosure;

FIG. 11 is a flowchart of a method for communicating an SL-PRS according to some embodiments of the present disclosure;

FIG. 12 is a flowchart of a method for communicating an SL-PRS according to some embodiments of the present disclosure;

FIG. 13 is a flowchart of a method for communicating an SL-PRS according to some embodiments of the present disclosure;

FIG. 14 is a flowchart of a method for communicating an SL-PRS according to some embodiments of the present disclosure;

FIG. 15 is a schematic diagram of an apparatus for communicating an SL-PRS according to some embodiments of the present disclosure;

FIG. 16 is a schematic diagram of an apparatus for communicating an SL-PRS according to some embodiments of the present disclosure;

FIG. 17 is a schematic diagram of an apparatus for communicating an SL-PRS according to some embodiments of the present disclosure; and

FIG. 18 is a schematic structural diagram of a communication device according to some embodiments of the present disclosure;

### DETAILED DESCRIPTION

For clearer descriptions of the objectives, technical solutions, and advantages of the present disclosure, the embodiments of the present disclosure are further described in detail hereinafter with reference to the accompanying drawings. Embodiments are illustratively described herein and are illustrated in the accompanying drawings. Unless otherwise indicated, the same number in different accompanying drawings indicates the same or similar elements in following descriptions of the accompanying drawings. The following exemplary embodiments do not represent all embodiments consistent with the present disclosure, and are merely examples of devices and methods that are consistent with aspects of the present disclosure as detailed in the appended claims.

The network architecture and service scenarios described in the embodiments of the present disclosure are provided to more clearly illustrate the technical solutions of the embodiments, and do not constitute limitations on the technical solutions offered by these embodiments. As recognized by those skilled in the art, with the evolution of network architectures and emergence of new service scenarios, the technical solutions provided herein remain applicable to similar technical challenges. The terminology used in the present disclosure is employed solely for describing specific embodiments and does not purport to restrict the scope of the present disclosure. Singular forms such as “a,” “an,” and “the” used in the present disclosure and appended claims are intended to include plural forms unless otherwise expressly indicated by context. It should also be understood that the term “and/or” herein refers to and encompasses any or all possible combinations of one or more associated listed items.

It should be understood that although the terms “first,” “second,” “third,” and the like are used to describe various types of information in the present disclosure, such information should not be limited to the terms. The terms are used only to distinguish the same type of information. For example, without departing from the scope of the present disclosure, the first information is also be referred to as the second information, and likewise, the second information is also be referred to as the first information. Depending on the context, the term “if” used herein is interpreted as the term “when” “in a case where” or “determining in response to”

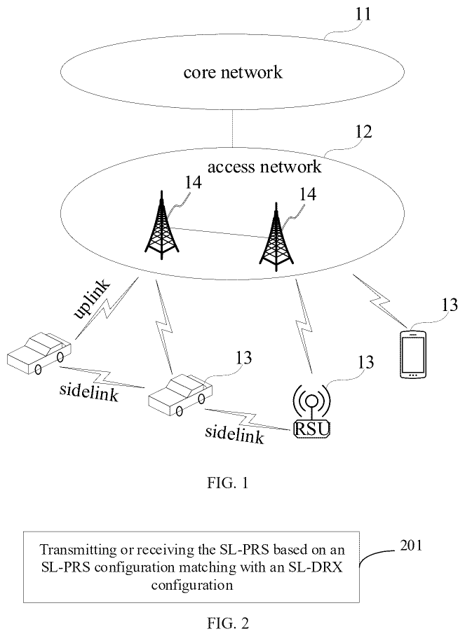

FIG. 1 illustrates an architecture diagram of a communication network according to some embodiments of the present disclosure. The architecture of a communication network involves: a core network 11, an access network 12, and a terminal 13.

The core network 11 includes several core network devices. The primary functions of the core network devices are to provide user connectivity, manage users, and complete service bearer functions, serving as an interface for the bearer network to connect to external networks. For example, the core network of the fifth-generation (5G) new radio (NR) system includes devices such as an access and mobility management function (AMF) entity, a user plane function (UPF) entity, and a session management function (SMF) entity.

The access network 12 contains multiple access network device 14. In the 5G NR system, this network is referred to as the new generation radio access network (NG-RAN). The access network device 14 is a device deployed in the access network 12 to provide wireless communication functions for terminal 13. The access network device 14 includes various forms of macro base stations, micro base stations, relay stations, access points, and so on. In systems employing different wireless access technologies, devices with access network devices functionality have the same name or different names. For example, in 5G NR systems, the device with access network devices functionality is referred to as a next generation Node-B (gNodeB or gNB). The term “access network device” will change or remain unchanged with the evolution of communication technologies. For ease of description, in the embodiments of the present disclosure, the aforementioned devices providing wireless communication functionality for the terminal 13 are collectively referred to as the access network device.

Typically, multiple terminals 13 are provided, and one or more terminals 13 are distributed within the cell managed by each of access network device 14. The terminal 13 includes various handheld devices, vehicle-mounted devices, wearable devices, computing devices, or other processing devices with wireless communication capabilities, as well as various forms of user equipment, mobile stations (MS), or the like. For ease of description, the aforementioned devices are collectively referred to as terminals. The access network device 14 communicates with the core network device through air interface technologies like the NG interface in 5G NR systems. The access network device 14 and the terminal 13 communicate with each other using the air interface technologies, such as a Uu interface.

The terminal 13 and the terminal 13, (e.g., vehicle-mounted devices and other devices (e.g., other vehicle-mounted devices, mobile phones, road side units (RSUs)), communicating with each other via a direct communication interface (e.g., a proximity communication (PC5) interface). Correspondingly, the communication link established based on the direct communication interface is referred to as a direct link or a sidelink. SL transmission refers to the direct communication and data transfer between terminals via a sidelink, which differs from traditional cellular systems where communication data is transmitted or received through access network devices. The SL transmission features low latency and minimal overhead, such that the SL transmission is suitable for communication between two geographically proximate terminals (e.g., vehicle-mounted devices and other nearby peripheral devices). The SL technology is applied to various scenarios requiring direct communication between terminals, such as vehicle-to-vehicle communications in V2X scenarios or vehicle-to-vehicle communications in SL positioning scenarios. Alternatively, the terminal in the present disclosure refers to any type of device that utilizes the SL technology for communication. The “5G NR system” in the embodiments of the present disclosure is also referred to as a 5G system or an NR system, and those skilled in the art is understand meaning of the 5G NR system. The technical solutions according to the embodiments of the present disclosure are applicable to the 5G NR system, as well as evolved systems of the 5G NR system. In the embodiments of the present disclosure, UE and terminal convey the same meaning and are used interchangeably.

The following provides an introduction to some relevant content involved in the embodiments of this disclosure.

### (1) SL-DRX

The sidelink supports SL-DRX for unicast (UC), groupcast (GC), and broadcast (BC). Parameters similar to those defined for Uu in Clause 11 (duration, inactivity timer, retransmission timer, cycle) are defined for SL to determine an SL active time for SL-DRX. During the SL active time, the UE monitors sidelink control information (SCI), which is used for data reception (i.e., second-stage SCI on physical sidelink control channel (PSCCH) and physical sidelink shared channel (PSSCH)). When the SL-DRX is inactive, the UE skips monitoring of the SCI used for data transmission.

The SL active time for the receiver (RX) terminal includes any applicable SL active time timer(s), SL inactivity-timer(s), or SL retransmission timer(s) (used for unicast, groupcast, or broadcast) that are currently running. Additionally, the slots associated with periodic transmissions announced by the transmitter (TX) terminal, and the time when the UE expects a channel state information (CSI) report following a CSI request (for unicast), are considered as the SL active time for the RX UE. The time of the unicast link establishment procedure specified in Clause and the time of the PC5 radio resource control (RRC) reconfiguration procedure with an initial SL-DRX configuration are also regarded as the SL active time of a RX UE.

For each pair of unicast source/destination layer 2 identifier (L2 ID) or groupcast/broadcast destination L2 ID, a TX UE maintains a set of timers corresponding to the SL-DRX timers in the RX UE. When data is available for transmission to one or more RX UEs configured with SL-DRX, the TX UE selects resources by considering the active time of the RX UE determined based on the timers maintained at the TX UE.

The relevant configuration parameters for SL-DRX are shown below.

### SL-DRX-ConfigGC-BC

IE SL-DRX-ConfigGC-BC is used to configure related parameters of DRX for NR sidelink groupcast and broadcast communications, direct link establishment requests based on unicast/broadcast communications, and discovery messages.

SL-DRX-ConfigGC-BC field description

sl-DefaultDRX-GC-BC
Indicates the default sidelink DRX configuration for groupcast and broadcast
communications, which is used for QoS profile(s) that cannot be mapped into DRX
configuration(s) configured for dedicated QoS profile(s). This field can be applied for the
broadcast based or unicast based communication of Direct Link Establishment Request
as described in protocol and discovery message as described in protocol.
sl-DRX-GC-BC-PerQoS-List
List of one or multiple sidelink DRX configurations for groupcast and broadcast
communication, which are mapped from QoS profile(s).
sl-DRX-GC-BC-periof
Value in ms, ms10 corresponds to 10 ms, ms20 corresponds to 20 ms, ms32
corresponds to 32 ms, and so on.
sl-DRX-GC-BC-MappedQoS-FlowsList
List of QoS profiles of the NR sidelink communication, which are mapped to a
sidelink DRX configuration.
sl-DRX-GC-BC-OnDurationTimer
Value in multiples of 1/32 ms (subMilliSeconds) or in ms (milliSecond). For the
latter, value ms1 corresponds to 1 ms, value ms2 corresponds to 2 ms, and so on.
sl-DRX-GC-HARQ-RTT-Timer1, sl-DRX-GC-HARQ-RTT-Timer2
Value in number of slot lengths of the BWP where the transport block was received.
Value sl0 corresponds to 0 slots, sl1 corresponds to 1 slot, sl2 corresponds to 2 slots, and
so on. sl-DRX-GC-HARQ-RTT-Timer1 is used for HARQ feedback enabled sidelink
retransmission if SCI does not indicate retransmission resource(s). sl-DRX-GC-HARQ-
RTT-Timer2 is used for HARQ feedback disabled sidelink retransmission in resource
pool configured with PSFCH if SCI does not indicate retransmission resource(s).
sl-DRX-GC-Generic
Indicates a sidelink DRX configuration for groupcast communication, which is
applicable to any QoS profile or any Destination Layer-2 ID.
sl-DRX-GC-InactivityTimer
Value in multiple integers of 1 ms, ms0 corresponds to 0, ms1 corresponds to 1 ms,
ms2 corresponds to 2 ms, and so on. This field is only valid for groupcast
communication.
sl-DRX-GC-RetransmissionTimer
Value in number of slot lengths of the BWP where the transport block was received.
Value sl0 corresponds to 0 slots, sl1 corresponds to 1 slot, sl2 corresponds to 2 slots, and
so on.

### SL-DRX-ConfigUC

IE SL DRX ConfigUC is used to configure related parameters of SL-DRX for unicast communication.

SL-DRX-ConfigUC field descriptions

sl-drx-CycleStartOffset
Sidelink drx-Cycle in ms and sidelink drx-StartOffset in multiples of 1 ms.
sl-drx-HARQ-RTT-Timer1, sl-drx-HARQ-RTT-Timer2
Value in number of slot lengths of the BWP where the transport block was received.
Value sl0 corresponds to 0 slots, sl1 corresponds to 1 slot, sl2 corresponds to 2 slots, and
so on. sl-drx-HARQ-RTT-Timer1 is used for HARQ feedback enabled sidelink
retransmission if SCI does not indicate retransmission resource(s). sl-drx-HARQ-RTT-
Timer2 is used for HARQ feedback disabled sidelink retransmission in resource pool
configured with PSFCH if SCI does not indicate retransmission resource(s).
sl-drx-InactivityTimer
Value in number of slot lengths of the BWP where the transport block was received,
sl0 corresponds to 0, sl1 corresponds to 1 slot, sl2 corresponds to 2 slots, and so on.
sl-drx-onDurationTimer
Value in multiples of 1/32 ms (subMilliSeconds) or in ms (milliSecond). For the
latter, value ms1 corresponds to 1 ms, value ms2 corresponds to 2 ms, and so on.
sl-drx-RetransmissionTimer
Value in number of slot lengths of the BWP where the transport block was received.
Value sl0 corresponds to 0 slots, sl1 corresponds to 1 slot, sl2 corresponds to 2 slots, and
so on.
sl-drx-SlotOffset
Value in 1/32 ms. Value 0 corresponds to 0 ms, value 1 corresponds to 1/32 ms, value
2 corresponds to 2/32 ms, and so on.

### SL-DRX-ConfigUC-SemiStatic

IE SL-DRX-ConfigUC-SemiStatic is used to indicate the semi-static SL-DRX related parameters for unicast communication.

### (2) Configuration for SL-PRS

SL-PRS resources refer to the time-frequency resources within dedicated SL-PRS resource pool time slots used for SL-PRS transmission.

For further study (FFS): used for shared resource pools.

Features related to SL-PRS resources include at least:
an SL-PRS resource ID;
an SL-PRS comb offset and a related SL-PRS comb size;
an SL-PRS start symbol and SL-PRS symbol number;
an SL-PRS frequency domain allocation;
Note: Other parameters are included when identifying;
FFS: Other time domain aspects (if any).

An SL-PRS resource is uniquely identified by an SL-PRS resource ID within a time slot of a dedicated SL-PRS resource pool.

### (3) Configuration Source

The configuration source of SL-PRS is either the SL-PRS transmitter terminal or the network device (e.g., base station), and the SL-PRS transmitter terminal or the network device configures the SL-PRS receiver terminal.

The configuration source of SL-DRX is the SL communication transmitter terminal (i.e., SL-DRX transmitter terminal) or network device (such as base stations).

During the SL positioning process, the SL-PRS transmitter terminal transmits the SL-PRS. At this time, in a case where the SL-PRS receiver device is in the sleep time of SL-DRX, two outcomes will occur. The first is that the SL-PRS receiver device does not perform the reception and measurement of SL-PRS, which is unfavorable for the implementation of SL positioning. The second is that the SL-PRS receiver device forcibly wakes up during the sleep time of SL-DRX to perform the reception and measurement of the SL-PRS, resulting in higher power consumption by the SL-PRS receiver terminal.

This disclosure provides a method for communicating an SL-PRS. When this method is applied to the SL positioning scenarios, the method realizes SL positioning while avoiding excessive power consumption by SL-PRS receiver terminals. Please refer to the following exemplary embodiments.

The terminal types mentioned in the embodiments of the present disclosure:

An SL communication receiver terminal: a terminal that performs SL communication with the SL communication transmitter terminal. The SL communication receiver terminal is used to receive SL data. In this disclosure, the SL communication receiver terminal uses the SL-DRX configuration to receive SL data. This SL-DRX configuration is configured by the SL communication transmitter terminal, or configured by network device, or preset at the factory.

An SL communication transmitter terminal: A terminal that performs SL communication with an SL communication receiver terminal. The SL communication transmitter terminal is used to transmit SL data. In this disclosure, the SL communication transmitter terminal utilizes the SL-DRX configuration for transmitting SL data.

An SL-PRS transmitter terminal: used for transmitting SL-PRS configurations and transmitting an SL-PRS.

An SL-PRS receiver terminal: used for receiving SL-PRS configurations and obtaining an SL-PRS.

In some embodiments, the SL communication receiver terminal undertakes the SL-PRS receiving service, and is also referred to as the SL-PRS receiver terminal. In some embodiments, the SL communication receiver terminal undertakes the SL-PRS transmission service. In this case, the SL communication receiver terminal is also referred to as the SL-PRS transmitter terminal.

In some embodiments, the SL communication receiver terminal undertakes the SL-PRS receiving service, and the SL communication transmitter terminal and the SL-PRS transmitter terminal are the same terminal or different terminals.

FIG. 2 shows a flowchart of a method for communicating an SL-PRS according to some embodiments of the present disclosure. The method is performed by an SL communication receiver terminal. The method includes the following steps.

In S201, the SL communication receiver terminal receives or transmits the SL-PRS based on an SL-PRS configuration matching an SL-DRX configuration.

### The SL Communication Receiver Terminal is Adapted to Transmit the SL-PRS:

The SL communication receiver terminal transmits the SL-PRS based on the SL-PRS configuration matching the SL-DRX configuration. Illustratively, the SL communication receiver terminal acts as the SL-PRS transmitter terminal and transmits the SL-PRS to the SL-PRS receiver terminal.

In some embodiments, the SL-PRS configuration for the SL communication receiver terminal is the SL-PRS configuration determined by the SL communication receiver terminal itself to match its own SL-DRX configuration. In some embodiments, the SL-PRS configuration for the SL communication receiver terminal is the SL-PRS configuration determined by a network device matching the DRX configuration for the SL communication receiver terminal. In some embodiments, the SL-PRS configuration for the SL communication receiver terminal is the SL-PRS configuration determined by the SL-PRS configuration configured by the network equipment matching the SL-DRX configuration for the SL-PRS receiver terminal.

### The SL Communication Receiver Terminal is Adapted to Receive the SL-PRS:

The SL communication receiver terminal receives the SL-PRS based on the SL-PRS configuration matching the SL-DRX configuration. Illustratively, the SL communication receiver terminal acts as an SL-PRS receiver terminal and receives the SL-PRS from the SL-PRS transmitter terminal.

In some embodiments, the SL-PRS configuration for the SL communication receiver terminal is configured for the SL communication receiver terminal by the SL-PRS transmitter terminal based on the SL-DRX configuration for the SL communication receiver terminal. In some embodiments, the SL-PRS configuration for the SL communication receiver terminal is configured for the SL communication receiver terminal by a network device based on the SL-DRX configuration for the SL communication receiver terminal.

Illustratively, the SL communication receiver terminal monitors the SL-PRS under the SL-PRS configuration matching the SL-DRX configuration during an active time for the SL-DRX configuration.

In some embodiments, a matching relationship between the SL-PRS configuration and the SL-DRX configuration includes at least one of: a cycle of single broadcast/groupcast/broadcast of the SL-PRS configuration being the same as that in the SL-DRX configuration; a transmission time of the SL-PRS of the SL-PRS configuration being located in the active time indicated in the SL-DRX configuration; or a slot length occupied by the SL-PRS of the SL-PRS configuration being less than or equal to the slot length of the active time in the SL-DRX configuration.

In some embodiments, the SL communication receiver terminal and the SL communication transmitter terminal perform transmission via end-to-end sidelink unicast. In some embodiments, the SL communication receiver terminal and the SL-PRS transmitter terminal perform transmission via end-to-end sidelink unicast. In some embodiments, the SL communication receiver terminal and the SL-PRS receiver terminal perform transmission via end-to-end sidelink unicast.

In some embodiments, a communication between the SL communication receiver terminal and the network device is transmitted via a relay terminal or a base station as a relay.

Illustratively, the SL communication receiver terminal transmits or receives SL-PRS based on the time-frequency resources, coding modes, cycles, slot lengths, and the like indicated in the SL-PRS configuration matches with the SL-DRX configuration.

In summary, in the method for communicating an SL-PRS according to the embodiments, transmitting or receiving the SL-PRS based on the SL-PRS configuration matching the SL-DRX configuration, enabling the SL-PRS receiver terminal to receive the SL-PRS during the active time for the SL-DRX. This avoids scenarios where the terminal transmits or receives the SL-PRS during the sleep time of the SL-DRX, which lead to failure in properly executing SL-PRS reception and measurement, or forcibly waking up during the sleep time of SL-DRX, thereby excessively consuming energy of the terminal, thereby saving power consumption of the terminal.

### 1. An SL Communication Receiver Terminal is Adapted to Receive an SL-PRS, and the SL-PRS Approaches to SL-DRX:

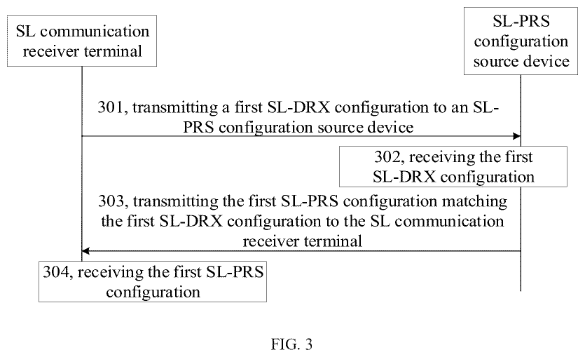

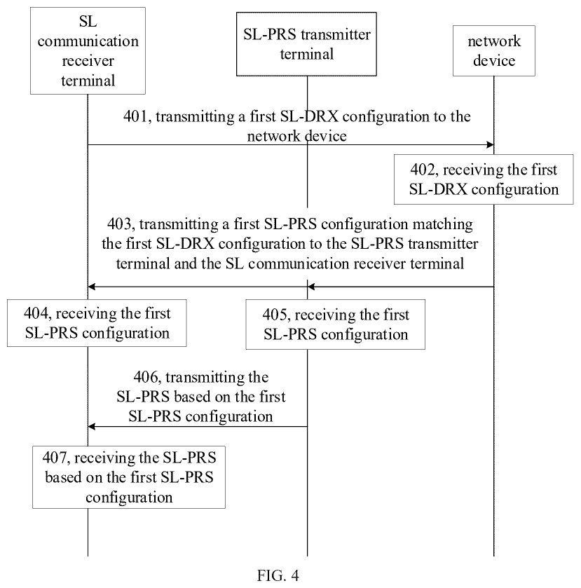

A method for configuring an SL-PRS in an SL communication receiver terminal is illustrated in FIG. 3. The method includes at least one of the following steps:

In S301, the SL communication receiver terminal transmits a first SL-DRX configuration to an SL-PRS configuration source device.

The first SL-DRX configuration is an SL-DRX configuration for the SL communication receiver terminal. The SL communication receiver terminal transmits its first SL-DRX configuration to the SL-PRS configuration source device.

In some embodiments, the SL-PRS configuration source device includes at least one of: a network device, an SL-PRS transmitter terminal, or an SL communication transmitter terminal.

The first SL-DRX configuration is directly transmitted from the SL communication receiver terminal to the SL-PRS configuration source device. Illustratively, the SL-PRS configuration source device includes at least one of: an SL-PRS transmitter terminal or an SL communication transmitter terminal. And the SL communication receiver terminal transmits the first SL-DRX configuration to the SL-PRS transmitter terminal or the SL communication transmitter terminal.

In some embodiments, the SL-PRS configuration source device is a network device. The first SL-DRX configuration is transmitted by the SL communication receiver terminal to a first terminal and then forwarded by the first terminal to the network device. The first terminal includes one of the following: an SL-PRS transmitter terminal, an SL communication transmitter terminal, or a relay terminal.

In S302, the SL-PRS configuration source device receives the first SL-DRX configuration.

The SL-PRS configuration source device receives the first SL-DRX configuration from the SL communication receiver terminal.

In S303, the SL-PRS configuration source device transmits the first SL-PRS configuration matching the first SL-DRX configuration to the SL communication receiver terminal.

Upon receiving the first SL-DRX configuration, the SL-PRS configuration source device determines the first SL-PRS configuration matching the first SL-DRX configuration and transmits the first SL-PRS configuration to the SL communication receiver terminal.

In some embodiments, the first SL-PRS configuration is directly transmitted from the SL-PRS configuration source device to the SL communication receiver terminal. Illustratively, the network device/the SL-PRS transmitter terminal/the SL communication transmitter terminal transmits the first SL-PRS configuration to the SL communication receiver terminal.

In some embodiments, the SL-PRS configuration source device is the network device. The above first SL-PRS configuration is transmitted by the network device to the first terminal and then transmitted by the first terminal to the SL communication receiver terminal.

It is noted that when the SL-PRS transmitter terminal and the SL communication transmitter terminal are the same terminal, the SL communication transmitter terminal is configured with the first SL-PRS configuration for the SL communication receiver terminal.

In some embodiments, when the SL-PRS configuration source device includes the SL-PRS transmitter terminal or the SL communication transmitter terminal, the SL communication receiver terminal and the SL-PRS configuration source device perform transmission via end-to-end sidelink unicast.

In S304, the SL communication receiver terminal receives the first SL-PRS configuration.

In some embodiments, the SL communication receiver terminal receives the first SL-PRS configuration from the SL-PRS configuration source device; or the SL communication receiver terminal receives the first SL-PRS configuration from the first terminal.

In some embodiments, the first SL-PRS configuration is an initial SL-PRS configuration in the SL-PRS receiver terminal or an updated SL-PRS configuration.

In some embodiments, as illustrated in FIG. 4, when an SL-PRS configuration source device as a network device and an SL communication receiver terminal are located within the service range of the network device, the method for communicating an SL-PRS includes the following steps.

In S401, the SL communication receiver terminal transmits a first SL-DRX configuration to the network device.

The SL communication receiver terminal directly transmits the first SL-DRX configuration to the network device to request the network device to configure an SL-PRS configuration for the SL communication receiver terminal and an SL-PRS transmitter terminal.

In S402, the network device receives the first SL-DRX configuration.

The network device receives the first SL-DRX configuration from the SL communication receiver terminal.

In S403, the network device transmits a first SL-PRS configuration matching the first SL-DRX configuration to the SL-PRS transmitter terminal and the SL communication receiver terminal.

The network device receives the first SL-DRX configuration and determines the first SL-PRS configuration matching the first SL-DRX configuration. The network device transmits the first SL-PRS configuration to the SL-PRS transmitter terminal and the SL communication receiver terminal respectively.

Illustratively, when the SL communication receiver terminal transmits the first SL-DRX configuration to the network device, the SL communication receiver terminal simultaneously transmits an SL communication receiver terminal identify (ID) and an SL-PRS transmitter terminal ID. Subsequently, after determining the first SL-PRS configuration, the network device transmits the first SL-PRS configuration to both the SL communication receiver terminal and the SL-PRS transmitter terminal based on the SL communication receiver terminal ID and the SL-PRS transmitter terminal ID.

In S404, the SL communication receiver terminal receives the first SL-PRS configuration.

In S405, the SL-PRS transmitter terminal receives the first SL-PRS configuration.

In some embodiments, the first SL-PRS configuration is an initial SL-PRS configuration in the SL-PRS transmitter terminal or an updated SL-PRS configuration.

In S406, the SL-PRS transmitter terminal transmits the SL-PRS based on the first SL-PRS configuration.

Illustratively, the SL communication receiver terminal and the SL-PRS transmitter terminal feed back confirmation information to the network device upon receiving the first SL-PRS configuration. The network device transmits an instruction information to the SL-PRS transmitter terminal to indicate the SL-PRS transmitter terminal to perform the SL-PRS transmission after receiving the confirmation information from both the SL-PRS receiver terminal and the SL-PRS transmitter terminal.

Illustratively, the SL-PRS transmitter terminal transmits the SL-PRS to the SL communication receiver terminal based on the first SL-PRS configuration. Illustratively, the SL-PRS transmitter terminal transmits the SL-PRS based on the time-frequency resources, coding modes, cycles, slot lengths, and the like indicated in the first SL-PRS configuration.

In S407, the SL communication receiver terminal receives the SL-PRS based on the first SL-PRS configuration.

Illustratively, the SL communication receiver terminal receives the SL-PRS from the SL-PRS transmitter terminal based on the first SL-PRS configuration. Illustratively, the SL communication receiver terminal receives the SL-PRS based on time-frequency resources, coding modes, cycles, slot lengths, and the like indicated in the first SL-PRS configuration.

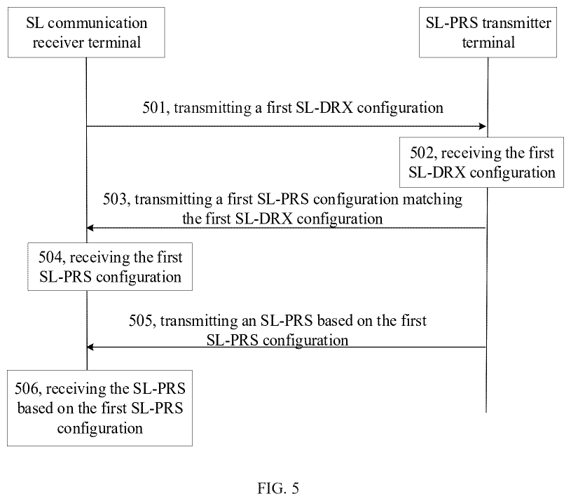

In some embodiments, the configuration process where the network device acts as the SL-PRS configuration source device in FIG. 4 alternatively is performed by the SL-PRS transmitter terminal serving as the SL-PRS configuration source device. As illustrated in FIG. 5, the method for communicating an SL-PRS includes the following steps:

In S501, an SL communication receiver terminal transmits a first SL-DRX configuration.

The SL communication receiver terminal transmits the first SL-DRX configuration to an SL-PRS transmitter terminal. The first SL-DRX configuration is an SL-DRX configuration currently used by the SL communication receiver terminal.

In S502, the SL-PRS transmitter terminal receives the first SL-DRX configuration.

The SL-PRS transmitter terminal receives the first SL-DRX configuration from the SL communication receiver terminal.

In S503, the SL-PRS transmitter terminal transmits a first SL-PRS configuration matching the first SL-DRX configuration.

The SL-PRS transmitter terminal determines the first SL-PRS configuration matching the first SL-DRX configuration. The SL-PRS transmitter terminal transmits the first SL-PRS configuration to the SL communication receiver terminal.

In some embodiments, the first SL-PRS configuration is an initial SL-PRS configuration in the SL-PRS transmitter terminal or an updated SL-PRS configuration.

In S504, the SL communication receiver terminal receives the first SL-PRS configuration.

The SL communication receiver terminal receives the first SL-PRS configuration configured for the SL communication receiver terminal by the SL-PRS transmitter terminal.

In S505, the SL-PRS transmitter terminal transmits an SL-PRS based on the first SL-PRS configuration.

In some embodiments, upon receiving the first SL-PRS configuration, the SL communication receiver terminal also transmits confirmation information to the SL-PRS transmitter terminal. Upon receiving the confirmation information, the SL-PRS transmitter terminal transmits the SL-PRS to the SL communication receiver terminal based on the first SL-PRS configuration.

Illustratively, the SL-PRS transmitter terminal transmits the SL-PRS to the SL communication receiver terminal based on the first SL-PRS configuration. Illustratively, the SL-PRS transmitter terminal transmits SL-PRS based on the time-frequency resources, coding modes, cycles, and the like indicated in the first SL-PRS configuration.

In S506, the SL communication receiver terminal receives the SL-PRS based on the first SL-PRS configuration.

Illustratively, the SL communication receiver terminal receives the SL-PRS from the SL-PRS transmitter terminal based on the first SL-PRS configuration. Illustratively, the SL communication receiver terminal receives the SL-PRS based on time-frequency resources, coding modes, cycles, and the like indicated in the first SL-PRS configuration.

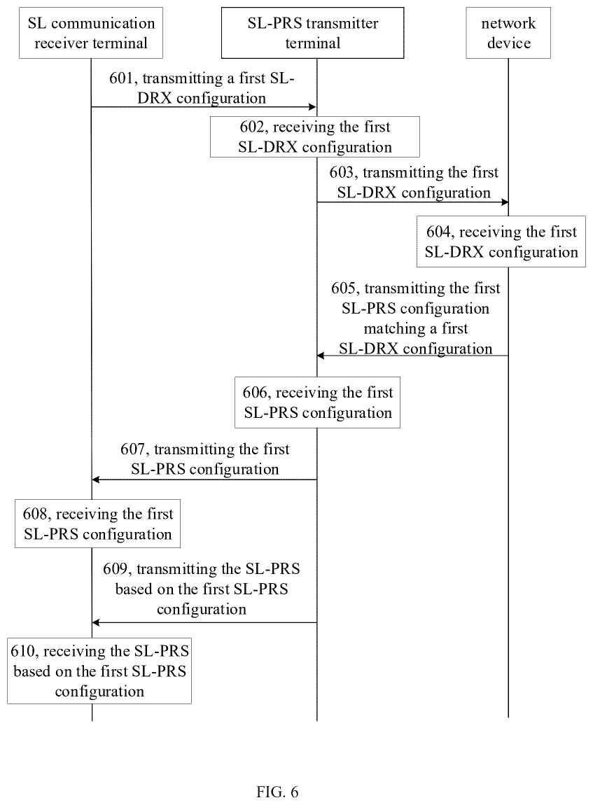

In some embodiments, when the network device serves as the SL-PRS configuration source device, the process where the SL communication receiver terminal requests the network device to perform an SL-PRS configuration in the embodiment illustrated in FIG. 4 is alternatively replaced by a step where the SL-PRS transmitter terminal requests the network device to perform SL-PRS configuration. As illustrated in FIG. 6, the method for communicating an SL-PRS includes the following steps:

In S601, an SL communication receiver terminal transmits a first SL-DRX configuration.

The SL communication receiver terminal transmits the first SL-DRX configuration to an SL-PRS transmitter terminal.

In S602, the SL-PRS transmitter terminal receives the first SL-DRX configuration.

The SL-PRS transmitter terminal receives the first SL-DRX configuration from the SL communication receiver terminal.

In S603, the SL-PRS transmitter terminal transmits the first SL-DRX configuration.

The SL-PRS transmitter terminal transmits the first SL-DRX configuration to a network device and requests the network device to configure the SL-PRS configuration matching the first SL-DRX configuration.

In S604, the network device receives the first SL-DRX configuration.

The network device receives the first SL-DRX configuration from the SL-PRS transmitter terminal.

In S605, the network device transmits the first SL-PRS configuration matching a first SL-DRX configuration.

Illustratively, the network device determines the first SL-PRS configuration matching the first SL-DRX configuration and transmits the first SL-PRS configuration to the SL-PRS transmitter terminal.

In S606, the SL-PRS transmitter terminal receives the first SL-PRS configuration.

The SL-PRS transmitter terminal receives the first SL-PRS configuration from the network device. In some embodiments, the first SL-PRS configuration is an initial SL-PRS configuration or an updated SL-PRS configuration.

Illustratively, in a case where there is no unused SL-PRS configuration in the SL-PRS transmitter terminal, the SL-PRS transmitter terminal directly configures the first SL-PRS configuration. Illustratively, in a case where there is a used SL-PRS configuration in the SL-PRS transmitter terminal, the SL-PRS configuration currently in use is updated to the first SL-PRS configuration.

In S607, the SL-PRS transmitter terminal transmits the first SL-PRS configuration.

The SL-PRS transmitter terminal transmits the first SL-PRS configuration to the SL communication receiver terminal.

In S608, the SL communication receiver terminal receives the first SL-PRS configuration.

The SL communication receiver terminal receives the first SL-PRS configuration from the SL-PRS transmitter terminal.

In some embodiments, after receiving the first SL-PRS configuration, the SL communication receiver terminal also transmits a confirmation information to the SL-PRS transmitter terminal to notify the SL-PRS transmitter terminal to perform the SL-PRS transmission.

In some embodiments, the first SL-PRS configuration is the initially configured SL-PRS configuration or the updated SL-PRS configuration.

Illustratively, in a case where where unused SL-PRS configuration in the SL communication receiver terminal is absent, the SL communication receiver terminal is directly adapted to use the first SL-PRS configuration. Illustratively, in a case where a used SL-PRS configuration in the SL communication receiver terminal is provided, the SL-PRS configuration currently in use is updated to the first SL-PRS configuration.

In S609, the SL-PRS transmitter terminal transmits the SL-PRS based on the first SL-PRS configuration.

In some embodiments, upon receiving the first SL-PRS configuration, the SL communication receiver terminal also transmits a confirmation information to the SL-PRS transmitter terminal; and upon receiving the confirmation message, the SL-PRS transmitter terminal transmits the SL-PRS to the SL communication receiver terminal based on the first SL-PRS configuration.

Illustratively, the SL-PRS transmitter terminal transmits the SL-PRS to the SL communication receiver terminal based on the first SL-PRS configuration. Illustratively, the SL-PRS transmitter terminal transmits the SL-PRS based on time-frequency resources, coding modes, cycles, and the like indicated in the first SL-PRS configuration.

In S610, the SL communication receiver terminal receives the SL-PRS based on the first SL-PRS configuration.

Illustratively, the SL communication receiver terminal receives the SL-PRS from the SL-PRS transmitter terminal based on the first SL-PRS configuration. Illustratively, the SL communication receiver terminal receives the SL-PRS based on time-frequency resources, coding modes, cycles, and the like indicated in the first SL-PRS configuration.

In some embodiments, it is noted that in the above three exemplary embodiments of method for communicating an SL-PRS implementation, the SL-PRS transmitter terminal is the same terminal as the SL communication transmitter terminal, or is a different terminal from the SL communication transmitter terminal.

In summary, in the method for communicating an SL-PRS according to the embodiments, the SL-PRS configuration source device to configure the first SL-PRS configuration matching the first SL-DRX configuration for the SL communication receiver terminal. Then, the SL-PRS transmitter terminal transmits the SL-PRS based on the first SL-PRS configuration, and the SL communication receiver terminal receives and measures the SL-PRS based on the first SL-PRS configuration. By configuring the first SL-PRS configuration to match the first SL-DRX configuration, the SL communication receiver terminal receives the SL-PRS during the active time for the SL-DRX. This avoids scenarios where the SL communication receiver terminal is in the sleep time of the SL-DRX, leading to failure in successfully performing SL-PRS reception and measurement, or where the SL communication receiver terminal is forced to wake up during the SL-DRX sleep time, excessively consuming energy of the SL communication receiver terminal.

### 2. An SL Communication Receiver Terminal is Adapted to Transmit an SL-PRS, and SL-PRS Approaches to SL-DRX:

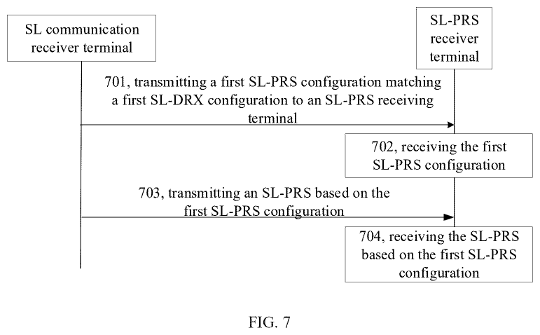

A method for communicating an SL-PRS in an SL communication receiver terminal is illustrated in FIG. 7. The method includes at least one of the following steps:

In S701, the SL communication receiver terminal transmits a first SL-PRS configuration matching a first SL-DRX configuration to an SL-PRS receiver terminal.

The SL communication receiver terminal transmits the first SL-PRS configuration to the SL-PRS receiver terminal. The first SL-PRS configuration matches the first SL-DRX configuration, and the first SL-DRX configuration is an SL-DRX configuration for the SL communication receiver terminal. Illustratively, the first SL-DRX configuration is the SL-DRX configuration currently in use by the SL communication receiver terminal.

In some embodiments, the first SL-PRS configuration is an initially configured SL-PRS configuration in the SL-PRS receiver terminal or an updated SL-PRS configuration.

In S702, the SL-PRS receiver terminal receives the first SL-PRS configuration.

The SL-PRS receiver terminal receives the first SL-PRS configuration from the SL communication receiver terminal. In some embodiments, the SL-PRS transmitter terminal feeds back a confirmation information to the SL communication receiver terminal after receiving the first SL-PRS configuration. The confirmation information is used to notify the SL communication receiver terminal to perform the transmission of the SL-PRS.

In some embodiments, the first SL-PRS configuration is the initially configured SL-PRS configuration in the SL-PRS receiver terminal or the updated SL-PRS configuration.

In S703, the SL communication receiver terminal transmits an SL-PRS based on the first SL-PRS configuration.

The SL communication receiver terminal transmits the SL-PRS to the SL-PRS receiver terminal based on the first SL-PRS configuration. Illustratively, the SL communication receiver terminal transmits the SL-PRS based on the time-frequency resources, coding modes, cycles, and the like indicated in the first SL-PRS configuration.

In S704, the SL-PRS receiver terminal receives the SL-PRS based on the first SL-PRS configuration.

The SL-PRS receiver terminal receives the SL-PRS from from the SL communication receiver terminal. Illustratively, the SL-PRS receiver terminal receives the SL-PRS based on time-frequency resources, coding modes, cycles, and the like indicated in the first SL-PRS configuration.

In some embodiments, the above first SL-PRS configuration is determined by the SL-PRS configuration source device; and the SL-PRS configuration source device includes one of the following: a network device or an SL communication receiver terminal.

Illustratively, the SL-PRS configuration source device as an SL communication receiver terminal; the SL communication receiver terminal determines the first SL-PRS configuration matching the first SL-DRX configuration, and then proceeds to S701. In the case where the SL communication receiver terminal and the SL-PRS transmitter terminal are the same terminal, the SL-PRS configuration source device is the SL communication receiver terminal.

Illustratively, the SL-PRS configuration source device is a network device. The network device determines the first SL-PRS configuration matching the first SL-DRX configuration. There are two scenarios for the network device to perform the SL-PRS configuration: first, the network device completes SL-PRS configuration within the coverage range of a single network device; second, the network device completes SL-PRS configuration within the coverage range of two network devices.

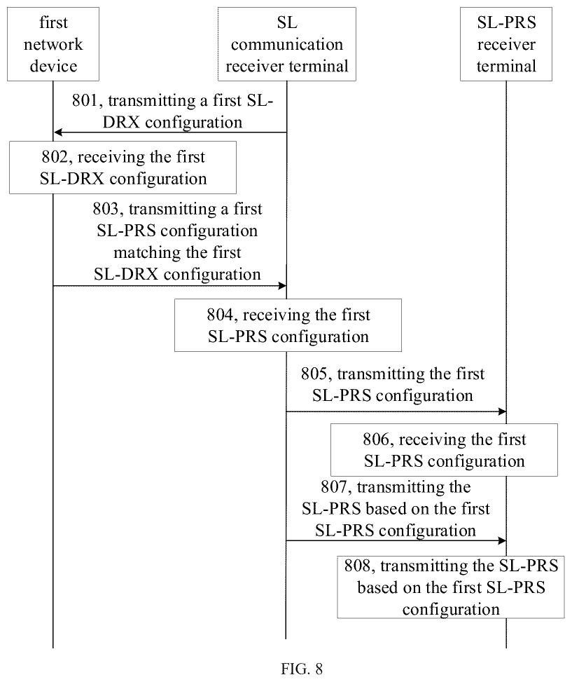

For the first case, as illustrated in FIG. 8, the method for communicating an SL-PRS includes the following steps:

In S801, an SL communication receiver terminal transmits a first SL-DRX configuration.

The SL communication receiver terminal transmits the first SL-DRX configuration to a first network device, and the SL communication receiver terminal requests a first network device to configure an SL-PRS configuration matching the first SL-DRX configuration for the SL communication receiver terminal.

In some embodiments, the SL communication receiver terminal transmits the first SL-DRX configuration to a relay terminal or a base station. The relay terminal or the base station transmits the first SL-DRX configuration to the first network device.

In S802, the first network device receives the first SL-DRX configuration.

The first network device receives the first SL-DRX configuration from the SL communication receiver terminal. In some embodiments, the first network device receives the first SL-DRX configuration relay from the relay terminal or the base station.

In S803, the first network device transmits a first SL-PRS configuration matching the first SL-DRX configuration.

Upon receiving the first SL-DRX configuration, the first network device determines the first SL-PRS configuration matching the first SL-DRX configuration and transmits the first SL-PRS configuration to the SL communication receiver terminal.

In some embodiments, the first network device transmits the first SL-PRS configuration to the relay terminal or the base station, and the relay terminal or the base station transmits the first SL-PRS configuration to the SL communication receiver terminal.

In S804, the SL communication receiver terminal receives the first SL-PRS configuration.

Illustratively, the SL communication receiver terminal receives the first SL-PRS configuration from the first network device.

In some embodiments, the SL communication receiver terminal receives the first SL-PRS configuration relay from the first network device through the relay terminal or the base station.

In some embodiments, the first SL-PRS configuration is an initial SL-PRS configuration in the SL-PRS receiver terminal or an updated SL-PRS configuration.

In S805, the SL communication receiver terminal transmits the first SL-PRS configuration.

The SL communication receiver terminal transmits the first SL-PRS configuration to the SL-PRS receiver terminal.

In S806, the SL-PRS receiver terminal receives the first SL-PRS configuration.

The SL-PRS receiver terminal receives the first SL-PRS configuration from the SL communication receiver terminal. Illustratively, the SL-PRS transmitter terminal feeds back a confirmation information to the SL communication receiver terminal after receiving the first SL-PRS configuration. The confirmation information is used to notify the SL communication receiver terminal to perform the transmission of the SL-PRS.

In some embodiments, the first SL-PRS configuration is the initially configured SL-PRS configuration in the SL-PRS receiver terminal or the updated SL-PRS configuration.

In S807, the SL communication receiver terminal transmits the SL-PRS based on the first SL-PRS configuration.

The SL communication receiver terminal transmits the SL-PRS to the SL-PRS receiver terminal based on the first SL-PRS configuration. Illustratively, the SL communication receiver terminal transmits the SL-PRS based on the time-frequency resources, coding modes, cycles, slot lengths, and the like indicated in the first SL-PRS configuration.

In S808, the SL communication receiver terminal transmits the SL-PRS based on the first SL-PRS configuration.

The SL-PRS receiver terminal receives the SL-PRS from the SL communication receiver terminal based on the first SL-PRS configuration. Illustratively, the SL communication receiver terminal receives the SL-PRS based on time-frequency resources, coding modes, cycle, slot length, and the like indicated in the first SL-PRS configuration.

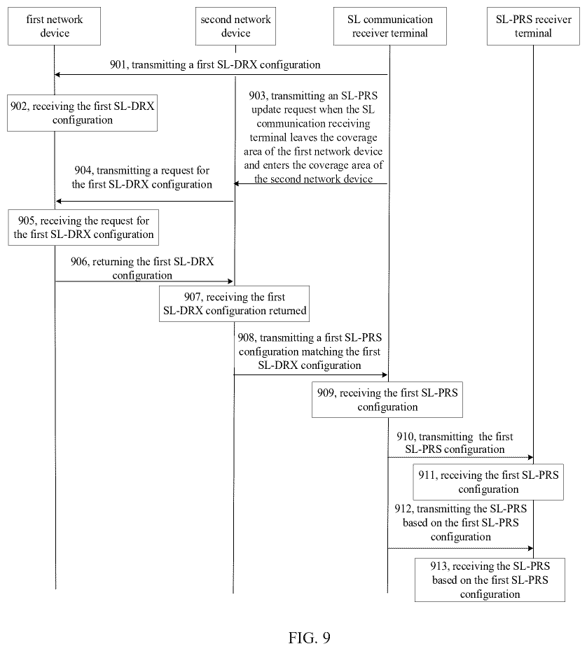

For the first case, as illustrated in FIG. 9, the method for communicating an SL-PRS includes the following steps:

In S901, an SL communication receiver terminal transmits a first SL-DRX configuration.

The SL communication receiver terminal is within the average range of a first network device and transmits the first SL-DRX configuration to the first network device. In some embodiments, the SL communication receiver terminal transmits the first SL-DRX configuration to a relay terminal or a base station. The relay terminal or the base station transmits the first SL-DRX configuration to the first network device.

In S902, the first network device receives the first SL-DRX configuration.

The first network device receives the first SL-DRX configuration from the SL communication receiver terminal. In some embodiments, the first network device receives the first SL-DRX configuration from a relay terminal or a base station as a relay.

In S903, the SL communication receiver terminal transmits an SL-PRS update request when the SL communication receiver terminal leaves the coverage area of the first network device and enters the coverage area of the second network device.

Illustratively, the SL communication receiver terminal transmits the first SL-DRX configuration. The SL communication receiver terminal requests the first network device to configure an SL-PRS configuration matching the first SL-DRX configuration. During the process of leaving the coverage range of the first network device, the SL communication receiver terminal does not receive the SL-PRS configuration configured by the first network device for the first SL-DRX configuration for the SL communication receiver terminal. Upon the SL communication receiver terminal entering the coverage range of the second network device, the SL communication receiver terminal transmits the SL-PRS update request to the second network device.

In some embodiments, the SL-PRS update request carries at least one of: an identifier (ID) of the SL communication receiver terminal; a cell identifier of the cell where the first network device is located, illustratively, cell-radio network temporary identifier (C-RNTI) and/or cell ID; or an expected SL-PRS configuration.

In some embodiments, the expected SL-PRS configuration is determined based on the first SL-PRS configuration. In some embodiments, the expected SL-PRS configuration is determined by the SL communication receiver terminal to match the first SL-DRX configuration.

In S904, a second network device transmits a request for the first SL-DRX configuration.

The second network device transmits the request for the first SL-DRX configuration to the first network device upon receiving the SL-PRS update request from the SL communication receiver terminal.

The second network device transmits the request for the first SL-DRX configuration to the first network device based on the cell identifier of the cell where the first network device is located in the SL-PRS update request, so as to obtain the first SL-DRX configuration.

In some embodiments, the request for the first SL-DRX configuration includes a UE context retrieval request. Illustratively, the second network device transmits the UE context retrieval request to the first network device.

In S905, the first network device receives the request for the first SL-DRX configuration.

The first network device receives the request for the first SL-DRX configuration from the second network device.

In some embodiments, the first network device receives the UE context retrieval request from the second network device.

In S906, the first network device returns the first SL-DRX configuration.

The first network device transmits the first SL-DRX configuration requested by the second network device to the second network device.

In some embodiments, the request for the first SL-DRX configuration carries an identifier of the SL communication receiver terminal, and the first network device acquires the first SL-DRX configuration from the SL communication receiver terminal to the first network device based on the identifier of the SL communication receiver terminal, and the first network device transmits the first SL-DRX configuration to the second network device.

In some embodiments, for the UE context retrieval request, the first network device transmits a UE context response to the second network device, and the UE context response includes the first SL-DRX configuration.

In S907, the second network device receives the first SL-DRX configuration returned.

The second network device receives the first SL-DRX configuration returned by the first network device. In some embodiments, the second network device receives the UE context response returned by the first network device.

In S908, the second network device transmits a first SL-PRS configuration matching the first SL-DRX configuration.

The second network device determines the first SL-PRS configuration matching the first SL-DRX configuration. The second network device transmits the first SL-PRS configuration to the SL communication receiver terminal. In some embodiments, the second network device determines that the expected SL-PRS configuration matches the first SL-DRX configuration, and the second network device designates the expected SL-PRS configuration as the first SL-PRS configuration.

In S909, the SL communication receiver terminal receives the first SL-PRS configuration.

The SL communication receiver terminal receives the first SL-PRS configuration configured by the second network device. In some embodiments, the first SL-PRS configuration is an initial SL-PRS configuration in the SL-PRS receiver terminal or an updated SL-PRS configuration.

In S910, the SL communication receiver terminal transmits the first SL-PRS configuration.

The SL communication receiver terminal transmits the first SL-PRS configuration to the SL-PRS receiver terminal.

In S911, the SL-PRS receiver terminal receives the first SL-PRS configuration.

The SL-PRS receiver terminal receives the first SL-PRS configuration from the SL communication receiver terminal. In some embodiments, the first SL-PRS configuration is the initial SL-PRS configuration in the SL-PRS receiver terminal or the updated SL-PRS configuration.

In S912, the SL communication receiver terminal transmits the SL-PRS based on the first SL-PRS configuration.

The SL communication receiver terminal transmits the SL-PRS to the SL-PRS receiver terminal based on the first SL-PRS configuration. Illustratively, the SL communication receiver terminal transmits the SL-PRS based on the time-frequency resources, coding modes, cycles, slot lengths, and the like indicated in the first SL-PRS configuration.

In S913, the SL-PRS receiver terminal receives the SL-PRS based on the first SL-PRS configuration.

The SL-PRS receiver terminal receives the SL-PRS from the SL communication receiver terminal based on the first SL-PRS configuration. Illustratively, the SL communication receiver terminal receives the SL-PRS based on time-frequency resources, coding modes, cycles, slot lengths, and the like indicated in the first SL-PRS configuration.

In summary, in the method for communicating an SL-PRS according to the embodiments, the SL communication receiver terminal or the network device configures the first SL-PRS configuration matching the first SL-DRX configuration for the SL communication receiver terminal. Then, the SL communication receiver terminal or the network device transmits the SL-PRS based on the first SL-PRS configuration, and the SL-PRS receiver terminal receives and measures the SL-PRS based on the first SL-PRS configuration. The SL-PRS receiver terminal receives the SL-PRS during the active time for the SL-DRX. This avoids scenarios where the SL-PRS receiver terminal is in the sleep time of the SL-DRX, leading to failure in successfully performing SL-PRS reception and measurement, or where the SL-PRS receiver terminal is forced to wake up during the SL-DRX sleep time, excessively consuming energy of the SL-PRS receiver terminal.

### 3. SL-DRX Approaches an SL-PRS:

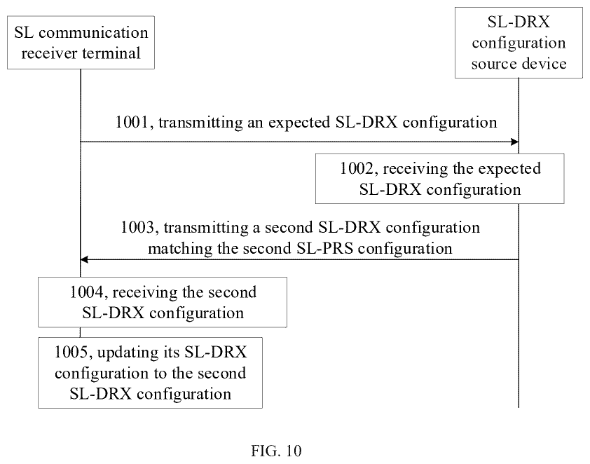

The embodiments illustrated in FIG. 3 to FIG. 9 described above determine the matching SL-PRS configuration based on SL-DRX configurations. There is another case where the matching SL-DRX configuration is determined based on the SL-PRS configuration. As illustrated in FIG. 10, the method for configuring SL-DRX includes the following steps:

In S1001, an SL communication receiver terminal transmits an expected SL-DRX configuration.

The SL communication receiver terminal transmits the expected SL-DRX configuration to an SL-DRX configuration source device. The expected SL-DRX configuration is determined based on the second SL-PRS configuration. In some embodiments, the second SL-PRS configuration is an SL-PRS configuration currently in use by either the SL-PRS transmitter terminal or the SL communication receiver terminal.

In some embodiments, the SL communication receiver terminal transmits assistance information to the SL-DRX configuration source device. The assistance information is used to notify the SL-DRX configuration source device of the expected SL-DRX configuration. In some embodiments, the assistance information is carried in a terminal assistance information SL message (UEAssistanceInformationSidelink msg).

For SL unicast, in a case where both a RX UE and the peer TX UE of the RX UE support the SL-DRX for side-link communication, when no an SL-DRX assistance information has been previously transmitted or when the previously transmitted SL-DRX assistance information has been modified, the RX UE transmitting the SL-DRX assistance information transmits a UEAssistanceInformationSidelink msg as SL-DRX assistance information to the peer UE of the RX UE.

For SL unicast, in a case where a UE is in an RRC_Connected state and performs an SL operation in resource allocation mode 1, the UE reports the SL-DRX assistance information to the network. The SL-DRX assistance information is contained in the UEAssistanceInformationSidelink msg received from the peer UE of the UE. In a case where the UE is in the RRC_Connected state and performs a sidelink operation in resource allocation mode 2, or the UE is in an RRC_Idle state or the UE is in an RRC_INACTIVE state or the UE is outside the coverage area, the UE configures SL-DRX ConfigUC for a peer UE of the UE. This configuration applies regardless of whether the UE has acquired sidelink DRX assistance information from the assistance information sidelink of the peer UE of the UE.

In some embodiments, the expected SL-DRX configuration is transmitted by the SL communication receiver terminal to a second terminal. The expected SL-DRX configuration is relayed to the SL-DRX configuration source device via the second terminal; the second terminal includes at least one of: a relay terminal or a base station.

That is, when the distance between the SL communication receiver terminal and the SL-DRX configuration source device is far, the SL communication receiver terminal relays the expected SL-DRX configuration to the SL-DRX configuration source device via the relay terminal or the base station. Therefore, the expected SL-DRX configuration is relayed to the SL-DRX configuration source device.

In S1002, the SL-DRX configuration source device receives the expected SL-DRX configuration.

The SL-DRX configuration source device receives the expected SL-DRX configuration from the SL communication receiver terminal.

In S1003, the SL-DRX configuration source device transmits a second SL-DRX configuration matching the second SL-PRS configuration.

The SL-DRX configuration source device determines the expected SL-DRX configuration as the second SL-DRX configuration. And the SL-DRX configuration source device transmits the second SL-DRX configuration matching the second SL-PRS configuration to the SL communication receiver terminal.

In some embodiments, the second SL-DRX configuration is transmitted by the SL-DRX configuration source device to the second terminal. The expected SL-DRX configuration is relayed to the SL-DRX configuration source device via the second terminal; the second terminal includes at least one of a relay terminal or a base station.

That is, when the distance between the SL communication receiver terminal and the SL-DRX configuration source device is far, the SL-DRX configuration source device relays the second SL-DRX configuration to the SL communication receiver terminal through the relay terminal or the base station. Thereby relaying and transmitting the second SL-DRX configuration to the SL communication receiver terminal.

In S1004, the SL communication receiver terminal receives the second SL-DRX configuration.

The SL communication receiver terminal receives the second SL-DRX configuration from the SL-DRX configuration source device.

In S1005, the SL communication receiver terminal updates its SL-DRX configuration to the second SL-DRX configuration.

In some embodiments, the SL-DRX configured source device includes at least one of the following: a network device, an SL communication transmitter terminal, or an SL-PRS transmitter device.

In some embodiments, during the execution of an SL-DRX configuration, the SL communication receiver terminal transmits a mapping list of QoS and DRX used by the SL communication receiver terminal and a QoS/data resource bearer (DRB) identifier currently used by the SL communication receiver terminal, such that the source device updates the mapping list of QoS and DRX. Illustratively, the SL communication receiver terminal transmits the SL-PRS configuration via Uu direct transmission or relays the SL-PRS configuration to the network device (such as a base station), and carries the QoS/DRB identifier currently used by the SL communication receiver terminal, such that the network device modifies the mapping list of QoS and DRX.

In some embodiments, the mapping list of QoS and DRX is included in sl-DefaultDRX-GC-BC-r17.

For SL communication, the SL communication receiver terminal transmits the sl-DefaultDRX-GC-BC-r17 containing the mapping list of QoS and DRX to the SL-PRS configuration source device.

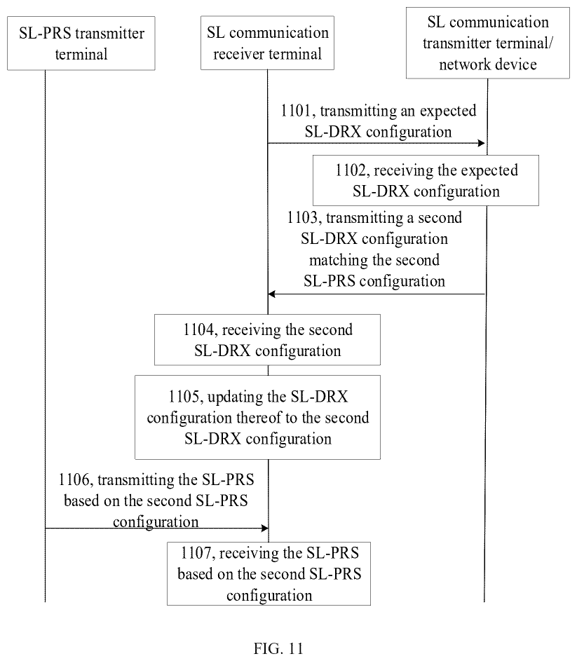

In some embodiments, the SL-DRX configuration source device includes a network device or an SL communication transmitter terminal, and the SL communication transmitter terminal is different from the SL-PRS transmitter device. As illustrated in FIG. 11, the method for communicating an SL-PRS includes the following steps:

In S1101, an SL communication receiver terminal transmits an expected SL-DRX configuration.

The SL communication receiver terminal transmits the expected SL-DRX configuration to an SL communication transmitter terminal/a network device. The expected SL-DRX configuration is determined based on a second SL-PRS configuration.

In S1102, the SL communication transmitter terminal/the network device receives the expected SL-DRX configuration.

The SL communication transmitter terminal/the network device receives the expected SL-DRX configuration from the SL communication receiver terminal.

In S1103, the SL communication transmitter terminal/the network device transmits a second SL-DRX configuration matching the second SL-PRS configuration.

The SL communication transmitter terminal/the network device determines the expected SL-DRX configuration as the second SL-DRX configuration, and transmits the second SL-DRX configuration matching the second SL-PRS configuration to the SL communication receiver terminal.

In S1104, the SL communication receiver terminal receives the second SL-DRX configuration.

The SL communication receiver terminal receives the second SL-DRX configuration from the SL communication transmitter terminal/the network device.

In S1105, the SL communication receiver terminal updates the SL-DRX configuration thereof to the second SL-DRX configuration.

When the SL communication receiver terminal is adapted to receive the SL-PRS and the second SL-PRS configuration is the SL-PRS configuration for the SL-PRS transmitter terminal, S1106 to S1107 are performed.

In S1106, the SL-PRS transmitter terminal transmits the SL-PRS based on the second SL-PRS configuration.

The SL-PRS transmitter terminal transmits the SL-PRS to the SL communication receiver terminal based on the second SL-PRS configuration. Illustratively, the SL-PRS transmitter terminal transmits the SL-PRS based on the time-frequency resources, coding modes, cycles, slot lengths, and the like indicated in the second SL-PRS configuration.

In S1107, the SL communication receiver terminal receives the SL-PRS based on the second SL-PRS configuration.

The SL communication receiver terminal receives the SL-PRS from the SL-PRS transmitter terminal based on the second SL-PRS configuration. Illustratively, the SL communication receiver terminal receives the SL-PRS based on time-frequency resources, coding modes, cycles, slot lengths, and the like indicated in the second SL-PRS configuration.

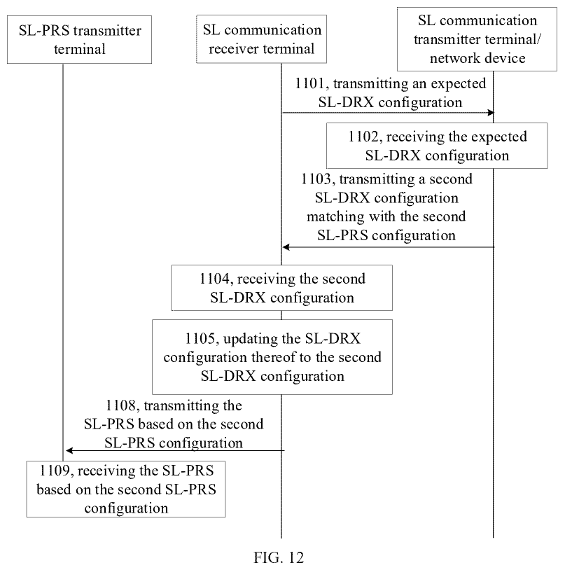

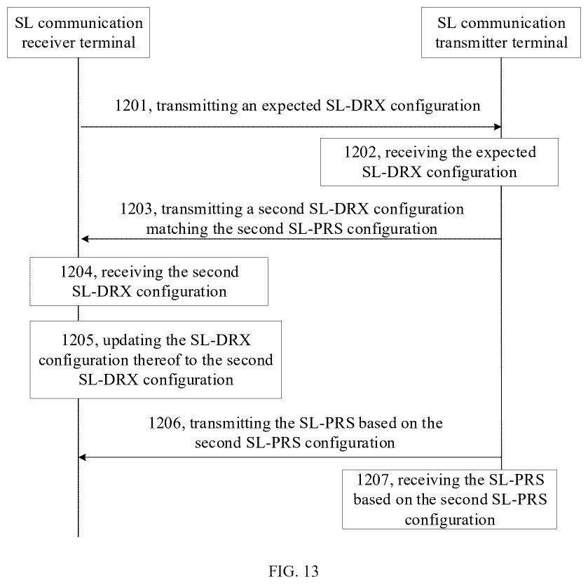

When the SL communication receiver terminal is adapted to transmit the SL-PRS and the second SL-PRS configuration is the SL-PRS configuration for the SL communication receiver terminal, S1108 to S1109 are performed as illustrated in FIG. 12.

In S1108, the SL communication receiver terminal transmits the SL-PRS based on the second SL-PRS configuration.

The SL communication receiver terminal transmits the SL-PRS to the SL-PRS receiver terminal based on the second SL-PRS configuration. Illustratively, the SL communication receiver terminal receives the SL-PRS based on time-frequency resources, coding modes, cycles, slot lengths, and the like indicated in the second SL-PRS configuration.

In S1109, the SL-PRS receiver terminal receives the SL-PRS based on the second SL-PRS configuration.

The SL-PRS receiver terminal receives the SL-PRS from the SL-PRS receiver terminal based on the second SL-PRS configuration. Illustratively, the SL-PRS receiver terminal receives the SL-PRS based on time-frequency resources, coding modes, cycles, slot lengths, and the like indicated in the second SL-PRS configuration.

In summary, in the method for communicating an SL-PRS according to the embodiments, the SL-DRX configuration source device configures the SL-DRX configuration matching the SL-PRS configuration for the SL communication transmitter terminal. Then, the SL-PRS receiver terminal measures the SL-PRS based on the SL-PRS configuration for the SL-PRS transmitter terminal. The SL-PRS receiver terminal receives the SL-PRS during the active time for the SL-DRX. This avoids scenarios where the SL-PRS receiver terminal is in the sleep time of the SL-DRX, leading to failure in successfully performing SL-PRS reception and measurement, or where the SL-PRS receiver terminal is forced to wake up during the SL-DRX sleep time, excessively consuming energy of the SL-PRS receiver terminal.

In some embodiments, the SL-DRX configuration source device includes a network device or an SL communication transmitter terminal, and the SL communication transmitter terminal is the same terminal as the SL-PRS transmitter device. As illustrated in FIG. 11, the method for communicating an SL-PRS includes the following steps:

In S1201, an SL communication receiver terminal transmits an expected SL-DRX configuration.

The SL communication receiver terminal transmits the expected SL-DRX configuration to the SL communication transmitter terminal. The expected SL-DRX configuration is determined based on the second SL-PRS configuration.

In S1202, the SL communication transmitter terminal receives the expected SL-DRX configuration.

The SL communication transmitter terminal receives the expected SL-DRX configuration from the SL communication receiver terminal.

In S1203, the SL communication transmitter terminal transmits a second SL-DRX configuration matching the second SL-PRS configuration.

The SL communication transmitter terminal determines the expected SL-DRX configuration as the second SL-DRX configuration. The SL communication transmitter terminal transmits the second SL-DRX configuration matching the second SL-PRS configuration to the SL communication receiver terminal.

In S1204, the SL communication receiver terminal receives the second SL-DRX configuration.

The SL communication receiver terminal receives the second SL-DRX configuration from the SL communication transmitter terminal.

In S1205, the SL communication receiver terminal updates the SL-DRX configuration thereof to the second SL-DRX configuration.

When the SL communication receiver terminal is adapted to receive the SL-PRS and the second SL-PRS configuration is the SL-PRS configuration for the SL communication receiver terminal, S1206 to S1207 are performed.

In S1206, the SL communication transmitter terminal transmits the SL-PRS based on the second SL-PRS configuration.

The SL communication transmitter terminal transmits the SL-PRS to the SL communication receiver terminal based on the second SL-PRS configuration. Illustratively, the SL communication transmitter terminal transmits the SL-PRS based on the time-frequency resources, coding modes, cycles, slot lengths, and the like indicated in the second SL-PRS configuration.

In S1207, the SL communication receiver terminal receives the SL-PRS based on the second SL-PRS configuration.

The SL communication receiver terminal receives the SL-PRS from the SL communication transmitter terminal based on the second SL-PRS configuration. Illustratively, the SL communication receiver terminal receives the SL-PRS based on time-frequency resources, coding modes, cycles, slot lengths, and the like indicated in the second SL-PRS configuration.

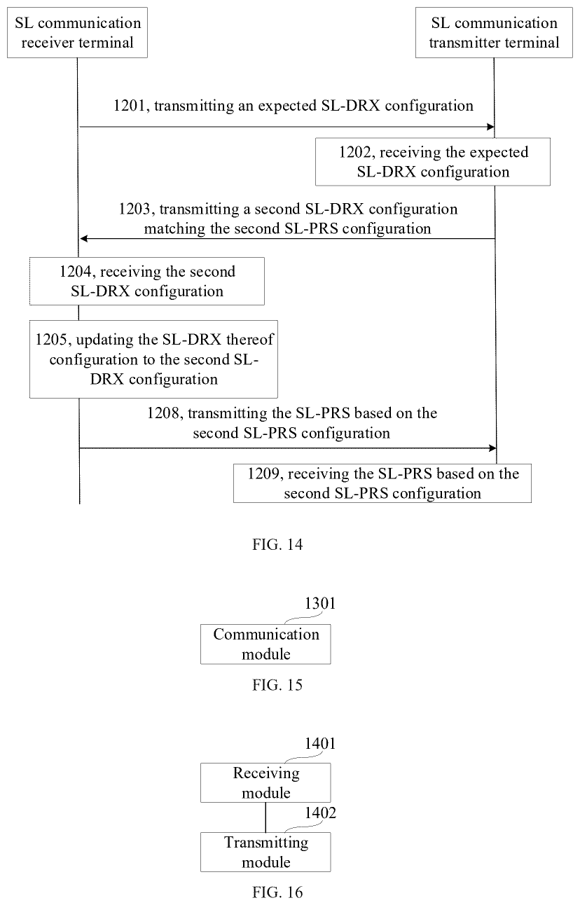

When the SL communication receiver terminal is adapted to transmit the SL-PRS and the second SL-PRS configuration is the SL-PRS configuration for the SL communication receiver terminal, S1208 to S1209 are performed as illustrated in FIG. 14.

In S1208, the SL communication receiver terminal transmits the SL-PRS based on the second SL-PRS configuration.

The SL communication receiver terminal transmits the SL-PRS to the SL communication receiver terminal based on the second SL-PRS configuration. Illustratively, the SL communication receiver terminal receives the SL-PRS based on time-frequency resources, coding modes, cycles, slot lengths, and the like indicated in the second SL-PRS configuration.

In S1209, the SL communication transmitter terminal receives the SL-PRS based on the second SL-PRS configuration.

The SL communication transmitter terminal receives the SL-PRS from the SL communication receiver terminal based on the second SL-PRS configuration. Illustratively, the SL communication transmitter terminal receives the SL-PRS based on time-frequency resources, coding modes, cycles, slot lengths, and the like indicated in the second SL-PRS configuration.

In summary, in the method for communicating an SL-PRS according to the embodiments, the SL communication transmitter terminal configures the second SL-DRX configuration matching the second SL-PRS configuration for the SL communication receiver terminal. Then the SL communication transmitter terminal performs SL-PRS measurement based on the second SL-PRS configuration and the second SL-DRX configuration matching the second SL-PRS configuration. The SL-PRS receiver terminal receives the SL-PRS during the active time for the SL-DRX. This avoids scenarios where the SL-PRS receiver terminal is in the sleep time of the SL-DRX, leading to failure in successfully performing SL-PRS reception and measurement, or where the SL-PRS receiver terminal is forced to wake up during the SL-DRX sleep time, excessively consuming the energy of the SL-PRS receiver terminal.

The following are the device embodiments of the present disclosure. For details not described in detail in the device embodiments, reference is made to the corresponding descriptions in the above method embodiments.

FIG. 15 illustrates a block diagram of an apparatus for communicating a sidelink positioning reference signal (SL-PRS) according to an exemplary embodiment of the present disclosure.

The apparatus includes: a communication module 1301, adapted to transmit or receive the SL-PRS based on an SL-PRS configuration matching an SL-DRX configuration.

In some embodiments, an SL communication receiver terminal is adapted to receive the SL-PRS.

The communication module 1301 is adapted to transmit a first SL-DRX configuration to an SL-PRS configuration source device. The first SL-DRX configuration is the SL-DRX configuration for the SL communication receiver terminal.

The communication module 1301 is adapted to receive a first SL-PRS configuration matching the first SL-DRX configuration.

The communication module 1301 is adapted to receive the SL-PRS based on the first SL-PRS configuration.

In some embodiments, the SL-PRS configuration source device includes one of: a network device, an SL-PRS transmitter terminal, or an SL communication transmitter terminal.

In some embodiments, the SL-PRS configuration source device is a network device. The first SL-DRX configuration is transmitted by the SL communication receiver terminal to a first terminal and then forwarded by the first terminal to the network device.

The first terminal includes one of: an SL-PRS transmitter terminal or an SL communication transmitter terminal.

In some embodiments, the SL-PRS configuration source device includes the SL-PRS transmitter terminal or the SL communication transmitter terminal.

The SL communication receiver terminal and the SL-PRS configuration source device perform transmission via end-to-end sidelink unicast.

In some embodiments, the SL communication receiver terminal is adapted to transmit the SL-PRS.

The communication module 1301 is adapted to transmit the first SL-PRS configuration matching the first SL-DRX configuration to an SL-PRS receiver terminal. The first SL-DRX configuration is a SL-DRX configuration for the SL communication receiver terminal.

The communication module 1301 is adapted to transmit the SL-PRS based on the first SL-PRS configuration.

In some embodiments, the first SL-PRS configuration is determined by the SL-PRS configuration source device; the SL-PRS configuration source device includes one of: a network device or an SL communication receiver terminal.

In some embodiments, the communication module 1301 is adapted to transmit the first SL-DRX configuration to a first network device.

The communication module 1301 is adapted to transmit an SL-PRS update request to a second network device in a case where the SL communication receiver terminal leaves a coverage area of the first network device and enters a coverage area of the second network device; the SL-PRS update request is used to request the second network device to update the SL-PRS configuration for the SL communication receiver terminal; the second network device is adapted to acquire a first SL-DRX configuration from the first network device in response to the SL-PRS update request, and configures a first SL-PRS configuration matching the first SL-DRX configuration for the SL communication receiver terminal.

The communication module 1301 is adapted to receive the first SL-PRS configuration which from the second network device.

In some embodiments, the SL-PRS update request carries at least one of: an identifier of the SL communication receiver terminal; a cell identifier of the cell where the first network device is located; or an expected SL-PRS configuration.

In some embodiments, the communication module 1301 is adapted to transmit the first SL-DRX configuration to the first network device; and the communication module 1301 is adapted to receive the first SL-PRS configuration from the first network device. The first SL-PRX configuration is determined by the first network device based on the first SL-DRX configuration.

In some embodiments, the communication module 1301 is adapted to transmit an expected SL-DRX configuration to an SL-DRX configuration source device. The expected SL-DRX configuration is determined based on a second SL-PRS configuration.

The communication module 1301 is adapted to receive the second SL-PRS configuration from the SL-DRX configuration source device.

The communication module 1301 is adapted to transmit or receive the SL-PRS based on the second SL-PRS configuration.

In some embodiments, the communication module 1301 is adapted to transmit assistance information to the SL-DRX configuration source device. The assistance information is used to notify the SL-DRX configuration source device of the expected SL-DRX configuration.

In some embodiments, the assistance information is carried in a terminal assistance information SL message.

In some embodiments, the communication module 1301 is adapted to transmit a mapping list of QoS and DRX used by the SL communication receiver terminal and a QoS/DRB identifier currently used by the SL communication receiver terminal to the SL-PRS configuration source device.

In some embodiments, the expected SL-DRX configuration is transmitted by the SL communication receiver terminal to a second terminal. The expected SL-DRX configuration is relayed to the SL-DRX configuration source device via the second terminal.

The second terminal includes at least one of a relay terminal or a base station.

In some embodiments, the SL-DRX configured source device includes at least one of: a network device, an SL communication transmitter terminal, or an SL-PRS transmitter device.

In some embodiments, a matching relationship between the SL-PRS configuration and the SL-DRX configuration includes: a cycle of single broadcast/groupcast/broadcast of the SL-PRS configuration being the same as that in the SL-DRX configuration; a transmission time of the SL-PRS of the SL-PRS configuration being located in an active time indicated in the SL-DRX configuration; or a slot length occupied by the SL-PRS of the SL-PRS configuration being less than or equal to a slot length of the active time in the SL-DRX configuration.

FIG. 16 illustrates a block diagram of an apparatus for communicating an SL-PRS according to some embodiments of the present disclosure.

The apparatus includes: a receiving module 1401, adapted to receive a first SL-DRX configuration, the first SL-DRX configuration is an SL-DRX configuration for an SL communication receiver terminal; and a transmitting module 1402, adapted to configure the first SL-PRS configuration matching the first SL-DRX configuration for the SL communication receiver terminal.

In some embodiments, the SL-PRS configuration source device includes one of: a network device, an SL-PRS transmitter terminal, or an SL communication transmitter terminal.

In some embodiments, the SL-PRS configuration source device is the SL-PRS transmitter terminal, and the transmitting module 1402 is adapted to transmit an SL-PRS based on the first SL-PRS configuration.

In some embodiments, the SL communication receiver terminal and the SL-PRS configuration source device perform transmission via end-to-end sidelink unicast.

In some embodiments, the SL-PRS configuration source device is the network device.

The transmitting module 1402 is adapted to configure the first SL-PRS configuration matching the first SL-DRX configuration for the SL-PRS transmitter terminal.

In some embodiments, the SL-PRS configuration source device is the network device.

The receiving module 1401 is adapted to receive the first SL-DRX configuration from the SL-PRS transmitter terminal, the first SL-DRX configuration is transmitted by the SL communication receiver terminal to the SL-PRS transmitter terminal.

The transmitting module 1402 is adapted to transmit the first SL-PRS configuration to the SL-PRS transmitter terminal, and the SL-PRS transmitter terminal transmits the first SL-PRS configuration to the SL communication receiver terminal.

In some embodiments, the receiving module 1401 is adapted to receive a mapping list of QoS and DRX used by the SL communication receiver terminal and a QoS/DRB identifier currently used by the SL communication receiver terminal from the SL communication receiver terminal.

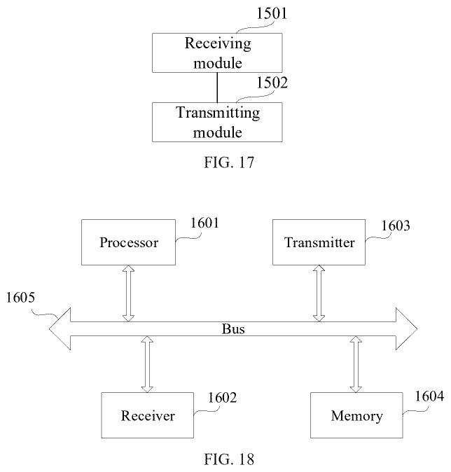

FIG. 17 illustrates a block diagram of an apparatus for communicating an SL-PRS according to some embodiments of the present disclosure.

The apparatus includes: a receiving module 1501, adapted to receive an expected SL-DRX configuration from an SL communication receiver terminal, the expected SL-DRX configuration is determined based on the second SL-PRS configuration; and a transmitting module 1502, adapted to transmit a second SL-DRX configuration matching the second SL-PRS configuration to the SL communication receiver terminal.

In some embodiments, the receiving module 1501 is adapted to receive an assistance information from the SL communication receiver terminal, the assistance information being used to notify the expected SL-DRX configuration to the SL-DRX configuration source device.

In some embodiments, the assistance information is carried in a terminal assistance information SL message.

In some embodiments, the expected SL-DRX configuration is transmitted by the SL communication receiver terminal to a second terminal. The expected SL-DRX configuration is relayed to the SL-DRX configuration source device via the second terminal.

The second terminal includes at least one of a relay terminal or a base station.

It is noted that the device provided in the above embodiments implements its functions by merely illustrating the division of each functional module. In practical applications, the aforementioned functions are assigned to different functional modules as needed. That is, the device is divided into different functional modules to implement all or part of the functions as described above.

As for the apparatus in the above embodiments, the specific way in which each module performs the operations has been described in detail in the embodiments of the method, which is not described herein any further.

FIG. 18 is a schematic structural diagram of a communication device (a terminal device or a network device) according to some embodiments of the present disclosure. The communication device 1600 includes: a processor 1601, a receiver 1602, a transmitter 1603, a memory 1604, and a bus 1605.

The processor 1601 includes one or more processing cores, and achieves various functional applications and information processing by running software programs and modules.

The receiver 1602 and the transmitter 1603 are practiced as a communication assembly. The communication assembly is a communication chip.

The memory 1604 is communicably connected to the processor 1601 over the bus 1605. Illustratively, the processor 1601 is implemented as a first IC chip, while both the processor 1601 and the memory 1604 is jointly implemented as a second IC chip. The first or second chip is an application-specific integrated circuit (ASIC) chip.

The memory 1604 is used to store at least one computer program, and the processor 1601 is adapted to execute the at least one computer program to implement each step performed by the access point link device in the above method embodiments.

In addition, the memory 1604 is practiced by any type of volatile or non-volatile storage device or combinations thereof. The volatile or non-volatile storage device includes but is not limited to a random-access memory (RAM), a read-only memory (ROM), an erasable programmable read-only memory (EPROM), an electrically erasable programmable read-only memory (EEPROM), a flash memory, or other solid-state storage devices, a compact disc read-only memory (CD-ROM), a digital video disc (DVD) or other optical storage devices, a tape cartridge, a magnetic tape, a disk storage or other magnetic storage devices.

The present disclosure further provides a computer-readable storage medium storing one or more programs, the one or more programs, when loaded and run by a processor, cause the processor to perform the method for communicating an SL-PRS in the above method embodiments.

In some embodiments, the computer-readable storage medium includes: a ROM, a RAM, a solid state drive (SSD), or a disk. The random access memory includes a resistive random-access memory (ReRAM) and a dynamic random-access memory (DRAM).

Some embodiments of the present disclosure further provide a chip. The chip includes programmable logical circuitry or one or more programs, the chip, when operating on a multi-link device, is caused to perform the method for communicating an SL-PRS in the above method embodiments.

Some embodiments of the present disclosure further provide a computer program product or a computer program. The computer program product or the computer program includes one or more computer instructions, the one or more computer instructions are stored in a computer-readable storage medium, the processor of the link device reads and executes the computer instructions from the computer-readable storage medium, causes the computer device to perform the method for communicating an SL-PRS in the above method embodiments.

It is understood that the term “indication” mentioned in the embodiments of this disclosure is refer to direct indication, indirect indication, or an expression of a relationship. Illustratively, when A indicates B, it means A directly indicates B (e.g., B being obtainable through A), or A indirectly indicates B (e.g., A indicating C through which B is obtained), or it indicates an inherent relationship between A and B.

In the description of the embodiments of this disclosure, the term “correspondence” indicates a direct or indirect relationship between the two, is also denote an associative relationship, or is refer to relationships such as indication and being indicated, configuration and being configured, etc. In some embodiments,

In this paper, the term “a plurality of” refers to two or more. The term “and/or” describes the association relationship between related objects, indicating that three types of relationships are exist. For example, the phrase “A and/or B” means (A), (B), or (A and B). The character “/” generally indicates that the associated objects are in an “or” relationship.

The step numbers described in this article are merely illustrative of one possible execution sequence between steps. In some other embodiments, the aforementioned steps are also executed in a non-numbered order, such as two steps with different numbers being executed simultaneously or in the reverse order of the illustrated sequence. The embodiments of this disclosure impose no limitations in this regard.

Those skilled in the art of Homo sapiens are able to consciousness that in one or more of the above examples, the functions described in the embodiments of this disclosure are implemented in hardware, software, firmware, or any combination thereof. When implemented in software, these functions are stored on a computer-readable medium or transmitted as one or more instructions or codes on the computer-readable medium. Computer-readable media include both computer storage media and communication media, where communication media includes any medium that facilitates the transfer of computer programs from one location to another. Storage media is any available medium that is accessed by a general-purpose or special-purpose computer.

Described above are merely optional embodiments of the present disclosure and are not intended to limit the present disclosure. Any modifications, equivalent replacements, improvements, and the like made within the spirit and principle of the present disclosure shall fall within the protection scope of the present disclosure.

What is claimed is:

1. A method for communicating a sidelink positioning reference signal (SL-PRS), performed by a sidelink (SL) communication receiver terminal, the method comprising:
transmitting or receiving the SL-PRS based on an SL-PRS configuration matching a sidelink discontinuous reception (SL-DRX) configuration.

2. The method according to claim 1, wherein:
the SL communication receiver terminal is adapted to receive the SL-PRS, and the method further comprises:
transmitting a first SL-DRX configuration to an SL-PRS configuration source device, wherein the first SL-DRX configuration is an SL-DRX configuration for the SL communication receiver terminal; and
receiving a first SL-PRS configuration matching the first SL-DRX configuration; and
receiving the SL-PRS based on the SL-PRS configuration matching the SL-DRX configuration comprises:
receiving the SL-PRS based on the first SL-PRS configuration.

3. The method according to claim 2, wherein:
the SL-PRS configuration source device comprises at least one of: a network device;
an SL-PRS transmitter terminal; or
an SL communication transmitter terminal.

4. The method according to claim 3, wherein:
the SL-PRS configuration source device comprises the SL-PRS transmitter terminal or the SL communication transmitter terminal; and
the SL communication receiver terminal and the SL-PRS configuration source device perform transmission via end-to-end sidelink unicast.

5. The method according to claim 1, wherein:
the SL communication receiver terminal is adapted to transmit the SL-PRS, and the method further comprises:
transmitting a first SL-PRS configuration matching a first SL-DRX configuration to an SL-PRS receiver terminal, wherein the first SL-DRX configuration is an SL-DRX configuration for the SL communication receiver terminal, wherein the first SL-PRS configuration is determined by a SL-PRS configuration source device; and the SL-PRS configuration source device comprises one of: a network device or an SL communication receiver terminal; and
transmitting the SL-PRS based on the SL-PRS configuration matching the SL-DRX configuration comprises:
transmitting the SL-PRS based on the first SL-PRS configuration.

6. The method according to claim 5, further comprising:
transmitting the first SL-DRX configuration to a first network device;
transmitting an SL-PRS update request to a second network device in a case where the SL communication receiver terminal leaves a coverage area of the first network device and enters a coverage area of the second network device; wherein the SL-PRS update request is used to request the second network device to update the SL-PRS configuration for the SL communication receiver terminal; and the second network device is adapted to acquire the first SL-DRX configuration from the first network device in response to the SL-PRS update request, and configure the first SL-PRS configuration matching the first SL-DRX configuration for the SL communication receiver terminal; and
receiving the first SL-PRS configuration from the second network device.

7. The method according to claim 6, wherein the SL-PRS update request carries at least one of:
an identifier of the SL communication receiver terminal;
a cell identifier of a cell where the first network device is located; or
an expected SL-PRS configuration.

8. The method according to claim 5, wherein the network device comprises a first network device, and the method further comprises:
transmitting the first SL-DRX configuration to the first network device; and
receiving the first SL-PRS configuration from the first network device, wherein the first SL-PRS configuration is determined by the first network device based on the first SL-DRX configuration.

9. The method according to claim 1, further comprising:
transmitting an expected SL-DRX configuration to an SL-DRX configuration source device, wherein the expected SL-DRX configuration is determined based on a second SL-PRS configuration; and
receiving the second SL-PRS configuration from the SL-DRX configuration source device;
wherein transmitting or receiving the SL-PRS based on the SL-PRS configuration matching the SL-DRX configuration comprises:
transmitting or receiving the SL-PRS based on the second SL-PRS configuration.

10. The method according to claim 9, wherein transmitting the expected SL-DRX configuration to the SL-DRX configuration source device comprises:
transmitting assistance information to the SL-DRX configuration source device, wherein the assistance information is used to notify the SL-DRX configuration source device of the expected SL-DRX configuration, and the assistance information is carried in a terminal assistance information SL message.

11. The method according to claim 9, further comprising:
transmitting a mapping list of quality of service (QoS) and DRX used by the SL communication receiver terminal and a QoS/data resource bearer (DRB) identifier currently used by the SL communication receiver terminal to an SL-PRS configuration source device.

12. The method according to claim 9, wherein the SL-DRX configuration source device comprises at least one of:
a network device;
an SL communication transmitter terminal; or
an SL-PRS transmitter device.

13. The method according to claim 1, wherein a matching relationship between the SL-PRS configuration and the SL-DRX configuration comprises at least one of:
a cycle of single broadcast/groupcast/broadcast of the SL-PRS configuration being the same as that in the SL-DRX configuration;
a transmission time of the SL-PRS of the SL-PRS configuration being located in an active time indicated in the SL-DRX configuration; or
a slot length occupied by the SL-PRS of the SL-PRS configuration being less than or equal to a slot length of the active time in the SL-DRX configuration.

14. A communication device, comprising: a processor, a transceiver connected to the processor, and a memory storing one or more executable instructions; wherein the one or more executable instructions, when loaded and executed by the processor, cause the processor to:
receive a first sidelink discontinuous reception (SL-DRX) configuration, wherein the first SL-DRX configuration is an SL-DRX configuration for a sidelink (SL) communication receiver terminal; and
configure a first SL-PRS configuration matching the first SL-DRX configuration for the SL communication receiver terminal.

15. The communication device according to claim 14, wherein the communication device is a SL-PRS configuration source device comprising one of:
a network device;
an SL-PRS transmitter terminal; or
an SL communication transmitter terminal.

16. The communication device according to claim 15, wherein the SL-PRS configuration source device is the SL-PRS transmitter terminal, wherein the one or more executable instructions, when loaded and executed by the processor, cause the processor to:
transmit an SL-PRS based on the first SL-PRS configuration; wherein the SL communication receiver terminal and the SL-PRS configuration source device perform transmission via end-to-end sidelink unicast.

17. The communication device according to claim 15, wherein:
the SL-PRS configuration source device is the network device, and the one or more executable instructions, when loaded and executed by the processor, cause the processor to:
configure the first SL-PRS configuration matching the first SL-DRX configuration for the SL-PRS transmitter terminal;
the one or more executable instructions, when loaded and executed by the processor, cause the processor to:
receive the first SL-DRX configuration from the SL-PRS transmitter terminal, wherein the first SL-DRX configuration is transmitted by the SL communication receiver terminal to the SL-PRS transmitter terminal; and
configuring the first SL-PRS configuration matching the first SL-DRX configuration for the SL communication receiver terminal comprises:
transmit the first SL-PRS configuration to the SL-PRS transmitter terminal, and the SL-PRS transmitter terminal transmits the first SL-PRS configuration to the SL communication receiver terminal.

18. The communication device according to claim 14, wherein the one or more executable instructions, when loaded and executed by the processor, cause the processor to:
receive a mapping list of quality of service (QoS) and DRX used by the SL communication receiver terminal and a QoS/data resource bearer (DRB) identifier currently used by the SL communication receiver terminal from the SL communication receiver terminal.

19. A communication device, comprising: a processor, a transceiver connected to the processor, and a memory storing one or more executable instructions; wherein the one or more executable instructions, when loaded and executed by the processor, cause the processor to:
receive an expected SL-DRX configuration from a sidelink (SL) communication receiver terminal, wherein the expected SL-DRX configuration is determined based on a second SL-PRS configuration; and
transmit a second SL-DRX configuration matching the second SL-PRS configuration to the SL communication receiver terminal.

20. The communication device according to claim 19, wherein the one or more executable instructions, when loaded and executed by the processor, cause the processor to:
receive assistance information from the SL communication receiver terminal, wherein the assistance information is used to notify the expected SL-DRX configuration to an SL-DRX configuration source device, and the assistance information is carried in a UE assistance information SL message.
